(19) United States
(12) Patent Application Publication
(10) Pub. No.: US 2024/0003112 A1
(43) Pub. Date: Jan. 4, 2024

(54) FOUNDATION FOR A WIND TURBINE

(71) Applicant: ANKER WERK I PORT MUKRAN GMBH, Sassnitz (DE)

(72) Inventors: Gregor PRASS, Hamburg (DE); Christoph SCHRIEFER, Redefin (DE)

(21) Appl. No.: 18/028,670

(22) PCT Filed: Sep. 23, 2021
(86) PCT No.: PCT/EP2021/076159

§ 371 Date: Mar. 27, 2023

(30) Foreign Application Priority Data
Sep. 29, 2020 (DE) 10 2020 125 441.5

(51) Int. Cl. E02D 27/42; E02D 5/80; E04H 12/22; E02D 27/01

(52) U.S. Cl. CPC E02D 27/425; E02D 5/801; E04H 12/2238; E02D 27/016; E02D 2300/002; E02D 27/08

(57) ABSTRACT

The invention relates to a foundation for a wind power plant, wherein the foundation (10) comprises substantially prefabricated elements, preferably of reinforced concrete, with a first, vertically extending base-like section (11), on which a tower of the wind power plant can be arranged, and a second, substantially horizontally extending section (12) as foundation body, which is in contact with the ground (100), wherein the first section (11) is arranged above the second section (12). Thereby, according to the invention, it is provided that the first vertically extending base-like section (11) is formed of at least three layers (13, 16, 17) arranged one above the other, of which the upper and the lower layer (13, 17) comprise at least two ring-like layers (13a, 13b, 17a, 17b) and the middle layer (16) is formed from at least one ring-like layer (16a), in that the height (H+I, 2×I) of the upper and/or lower layer (13, 17) is less than the height (J) of the middle layer (16), and in that the layers (13, 16, 17) are vertically braced to the second section (12) by means of at least two vertical tendons (19).

The invention relates to a foundation for a wind turbine, the foundation comprising substantially prefabricated elements, preferably of reinforced concrete, with a first vertically extending base-like section on which a tower of the wind turbine can be arranged, and a second substantially horizontally extending section as a foundation body which is in contact with the ground, the first section being arranged above the second section.

Foundations for wind turbines are essentially constructed as in-situ concrete foundations. For this purpose, a pit is excavated at the erection site, which is then provided with a clean layer. The formwork and reinforcement are then erected and the whole is filled with concrete on site. In this process, a flat body is erected, if necessary with a base, see for example US 20160369520 A1 or WO 2008/036934 A2. Besides the transport effort due to the delivery of the concrete, formwork and reinforcement, this is very labor-intensive on site. Quality assurance is also costly or, depending on the weather, problematic. Furthermore, the dismantling after the end of the service life of the wind turbine is expensive and very time-consuming. This applies in particular to concrete towers for wind turbines, which ideally have a diameter to height ratio of approx. 1:10, so that diameters of 8 to 15 m are not uncommon. Foundations for such towers have so far been made in cast-in-place concrete. Furthermore, areas must be provided where the prestressing elements of the tower can be attached to the foundation and prestressed. The prestressing is carried out with devices provided for this purpose, which have to be brought into the prestressing areas. As abutments for prestressing or for attaching the prestressing elements (strands/cables), elaborate cantilever structures are usually provided inside the foundation, under which the devices are then brought. These structures are costly and in need of improvement.

Furthermore, there is in principle a need to construct wind turbine foundations from prefabricated elements, which would reduce or eliminate the aforementioned problems. In principle, the advantage of prefabrication is that the components can be produced in a standardized manner under defined conditions. It also reduces the amount of work required on site. Various approaches to this have been described in the state of the art.

For example, WO 2008/036934 A2 shows a combination of precast elements and classic formwork/reinforcement construction. This reduces the previously mentioned disadvantages only insignificantly.

Other approaches for making foundations for wind turbines from prefabricated components are shown in the prior art as follows:

EP 1 058 787 B1 discloses a foundation for a wind turbine for erecting offshore wind turbines that are transported completely pre-assembled—i.e. including the foundation—and set down in one piece on the seabed at the erection site. The foundation has individual prefabricated segments. These can be made of concrete. A planar section and a base section are disclosed. The base section consists of circular rings. The planar section consists of individual base elements that are trapezoidal in base area, on which the base section is vertically mounted at the inner end, which has vertical passages. The flat base sections are connected to each other by means of tongue and groove joints. The base section and the flat base section are connected by a diagonal brace for bracing. The circular segments of the base section also have vertical passages. Connecting cables/anchor rods are inserted into the passages. If the foundation sections are to be made of concrete, a flat steel abutment ring is provided below the base elements in the area of the vertical passages. The foundation is mounted with the connecting cables/anchor rods and the wind turbine is fastened to the foundation. In addition, horizontal passages are provided in base elements and diagonal struts, in which connecting cables/anchor rods are also arranged, with which the elements of the foundation are horizontally prestressed. Only through the horizontal prestressing is the foundation completed in such a way that it can bear loads. Thus, EP 1 058 787 B1 discloses a foundation consisting of individual prefabricated concrete elements, with a surface section and a base section, whereby at least these two sections are connected to each other vertically and horizontally.

The disadvantage here is that considerable costs and labor are required for connecting the elements and producing the statically resilient foundation.

EP 1 074 663 A1 discloses a foundation for a wind turbine with a central body as a base with laterally extending star-shaped ribs/projections/beams bolted to it. Ribs and central body are horizontally bolted together on site. The parts are prefabricated from concrete, among other materials, and are delivered to the construction site by truck, arranged by crane and connected to each other horizontally on site via flanges and bolted connections. Furthermore, anchors are required on the outside of the ribs to ensure sufficient load transfer.

The disadvantage here is that here, too, considerable costs and labor are required for connecting the elements and producing the statically resilient foundation. Furthermore, additional anchors are necessary.

WO 2004/101898 A2 discloses a foundation for a wind turbine made of prefabricated concrete components, whereby either a central body is provided to which surface bodies are horizontally bolted, or the foundation consists exclusively of components having both a surface section and a base-like section, which are then horizontally connected to each other by bolting against flanges.

The disadvantage here is that here, too, considerable costs and labor are required for connecting the elements and producing the statically resilient foundation.

EP 2 182 201 A1 discloses two different foundations for a wind turbine. In both, a foundation is erected from prefabricated concrete components after appropriate delivery on site. Both contain a flat section and a base-like section. In Variant 1, a central body is provided. The ribs/area elements are attached to this. When assembled, the ribs form a polygonal body. The central body has a projection which is embraced by a corresponding recess on the ribs. The ribs are additionally locked against the central body by means of a lashing ring. Anchor rods are provided on the surface headers for mounting the tower. In the second variant, the ribs have horizontally projecting anchor elements which, when assembled, extend radially into the center of the foundation. Plates are provided below and above the anchors. In-situ concrete is placed in the cavity thus formed to connect the anchors and form a central body. In both variants, horizontal connection is simplified. However, both the ribs and the central body have dimensions and masses that make transportation complicated.

WO 2017/141095 A1 and WO 2017/141098 A1 also disclose a foundation for a wind turbine. This foundation is formed from prefabricated rib bodies, which have a base section at their inner end, on which the tower of the wind turbine is arranged. The ribs extend radially outward. In another embodiment, the sections between the ribs are filled with plate elements bolted against the ribs with flanges to form a plate. Centrally, instead of a central body, a steel sleeve is provided, which is connected to reinforcements provided inside the ribs and reinforcing beams provided in internal cavities. The ribs have a base plate. On which a diagonal reinforcing member and the base section are integrally arranged. The base sections are horizontally connected to each other via tongue and groove elements. Furthermore, the base sections have horizontal openings in which clamping elements are provided for horizontally connecting the base sections. Furthermore, anchor rods for connecting the tower to the foundation are cast in the base sections. Furthermore, external ground anchors are also disclosed.

The disadvantage here is that here, too, considerable costs and labor are required for connecting the elements and producing the statically resilient foundation.

WO 2019/115622 A1 and WO 2019/201714 A2 disclose first successful foundations for wind turbines made of precast concrete elements for a steel tower and for a concrete tower for a wind turbine. The foundations have two sections. Rib elements are provided, which have a central section on which a base section is provided. The tower of the wind turbine is then arranged on the base section. The base section consists of individual segments which are connected to each other. By means of tendons provided in openings in the central section and in the elements of the base section, the rib elements and the base elements are braced together. Further developments of these foundations have resulted in surprising and particularly efficient improvements in the area of the base.

The objective of the invention is therefore to overcome the aforementioned disadvantages and to make foundations for wind power plants, in particular for wind power plants with concrete towers, economically erectable or erectable from prefabricated elements.

The objective according to the invention is solved in that the first vertically extending base-like section is formed from at least three layers arranged one above the other, of which the upper and lower layers are formed from at least two ring-like layers and the middle layer is formed from at least one ring-like layer, in that the height of the upper and/or lower layer is less than the height of the middle layer, and in that the layers are vertically braced to the second section by means of at least two vertical tendons.

Such foundations according to the invention are suitable both for concrete towers and for steel towers. The advantage is that this type of foundation does not require any horizontal fasteners at all, while providing sufficient stability even in extreme load situations. Surprisingly, this is achieved in particular by the upper and lower layers comprising at least two ring-like layers in conjunction with bracing by prestressed tendons.

A further teaching of the invention provides that the height of the upper and lower layers is in total smaller than the height of the middle layer. Surprisingly, this makes it possible to achieve optimum load distribution in the foundation.

According to a further teaching of the invention, at least one of the layers comprises at least one prefabricated element, preferably reinforced concrete. Alternatively, it is provided that at least one of the layers comprises at least two precast elements, preferably of reinforced concrete. Further alternatively, it is provided that at least two adjacent layers comprise at least two prefabricated elements, preferably of reinforced concrete. This facilitates the standardized construction of the foundation and reduces the necessary number of transports to the construction site, in particular of in-situ concrete.

It is advantageous that the at least two elements are arranged butted and form the ring-like layer without horizontal fasteners in the vertical joints between the at least two elements. It is advantageous that the vertical joints are provided stress-free and/or that the at least two elements are arranged contact-free in the vertical joints. This in turn facilitates the standardized erection of the foundation and at the same time keeps costs low, because the prefabricated components in the area of the vertical butt joints, for example at distances of up to 3 cm, can be worked with tolerances customary in concrete construction during manufacture. Surprisingly, it has also been shown that such an arrangement provides sufficient stability in the foundation even in extreme load situations.

Another advantage is that the joints or vertical joints of two layers lying directly one above the other are not aligned. Surprisingly, it has been shown that it is possible to break down the individual ring-type layers into individual elements and at the same time achieve sufficient stability even in extreme load situations in the foundation.

According to another teaching of the invention, the prefabricated elements of the first and/or second sections are arranged connected to each other substantially without horizontal connecting means, preferably with vertical spacing between the prefabricated elements.

A further teaching of the invention provides that the prefabricated elements of the lower and/or upper layer have an increased reinforcement in the normal direction (tensile/compressive reinforcement) and/or that the prefabricated elements the middle layer have at least one increased reinforcement for dissipating shear loads, in particular in the radial direction. The provision of the reinforcements in the manner described above enables a cost-effective construction of the foundation.

According to a further teaching of the invention, at least one horizontal joint between the prefabricated elements of the first and/or second section are arranged one on top of the other free of in-situ concrete and/or mortar. It has been shown that providing horizontal contact between the prefabricated elements, if the prefabrication is sufficiently accurate (small tolerances in the horizontal direction of the prefabricated elements), sufficient friction in the horizontal joints is caused by the prestressing, so that sufficient stability is provided in the foundation even in extreme loading situations.

Another teaching of the invention provides that the prestressing by the at least two tendons is designed so that all horizontal joints between the layers are under pressure in any operating condition and in any extreme load condition of the wind turbine. Hereby, in a particularly simple manner, sufficient friction of the prefabricated elements is effected in particular in the horizontal joints between the prefabricated elements, so that the foundation is provided with sufficient stability even in extreme load situations, even without material-locking connections to the horizontal joints.

A further teaching of the invention provides that at least two ring-like abutments, preferably in the form of at least one abutment ring, are provided against which the tendons act, at least one abutment being arranged on the upper side of the first section and at least one abutment on the lower side of the second section. This provides in a simple manner the necessary load abutment for the tendons and the prestressing introduced thereabove. It is advantageous that at least one abutment and/or at least one abutment ring comprises at least two prefabricated elements which are arranged in abutment with the ring-like abutment and/or abutment ring. This facilitates the transport of the prefabricated elements. Furthermore, it is advantageous that at least one abutment has at least two layers arranged one above the other. This makes it possible to erect the foundation in a standardized manner as a function of the applied prestressing. It is also advantageous that the layers each have at least two elements that are arranged butted, with the butts of two layers lying directly above one another not being arranged in alignment. This avoids time-consuming welding work on site and reduces the construction time of the foundation. Furthermore, it becomes possible in a simple way to adequately transfer the loads of the prestressing via the abutment constructed in this way depending on the foundation design.

A further teaching of the invention provides that the second section is formed by at least three horizontal elements, and that the horizontal elements can be arranged as a function of the parameters of the tower to be erected, in particular the tower radius. It is advantageous that the horizontal elements are arranged laterally spaced apart from one another, or that the horizontal elements are arranged laterally parallel spaced apart from one another. This makes it possible in a particularly simple manner to provide a foundation depending on the dimensions of the tower to be erected. In particular, it is possible to create foundations for different tower radii with one type of horizontal element by shifting the horizontal elements in parallel accordingly.

A further teaching of the invention provides that the elements of the at least three layers of the first section have at least two substantially vertical apertures, in each of which a tension member, preferably a threaded rod or an anchor bolt with counter elements, is arranged. This makes it possible to provide the foundation quickly and cost-effectively in a particularly simple manner. When providing the openings, precise work with only minor deviations is necessary so that the tendons can be used and, at the same time, to effect the mountability of the prefabricated elements. This is facilitated in particular by the vertical spacing of the elements in a particularly simple manner.

In the following, the invention is explained in more detail by means of embodiment examples in connection with a drawing. Thereby show:

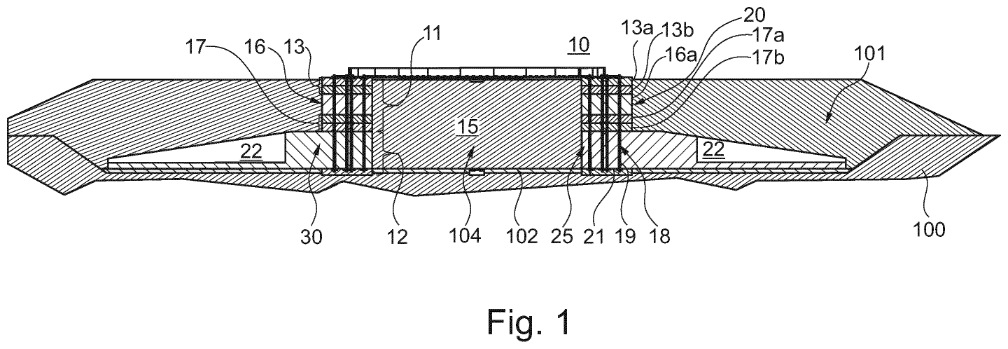

FIG. 1 a sectional view of a preferred embodiment of a foundation according to the invention

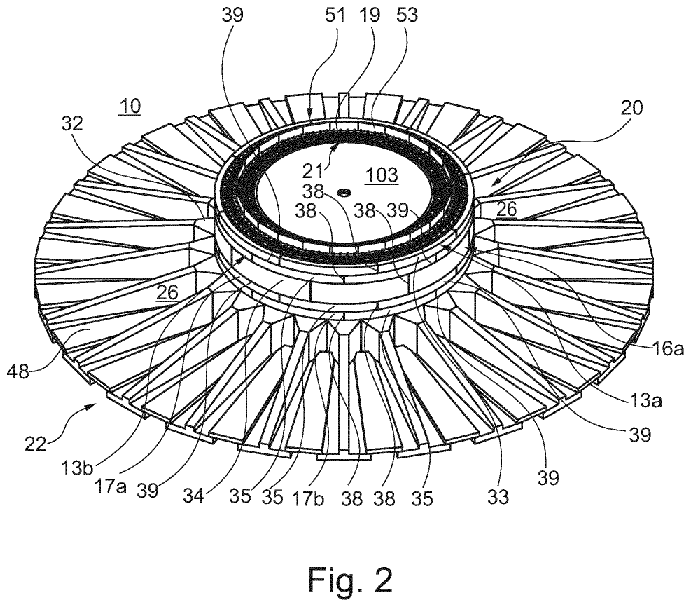

FIG. 2 a spatial view of FIG. 1,

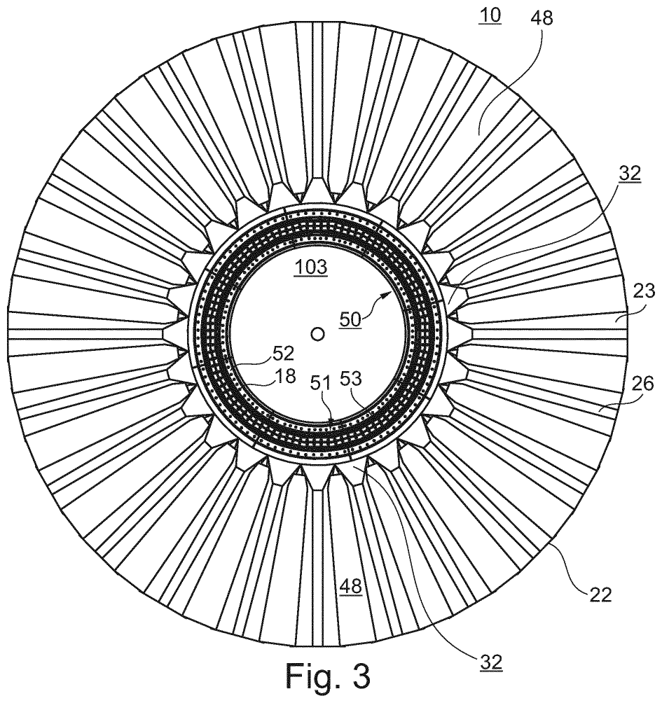

FIG. 3 a top view of FIG. 1,

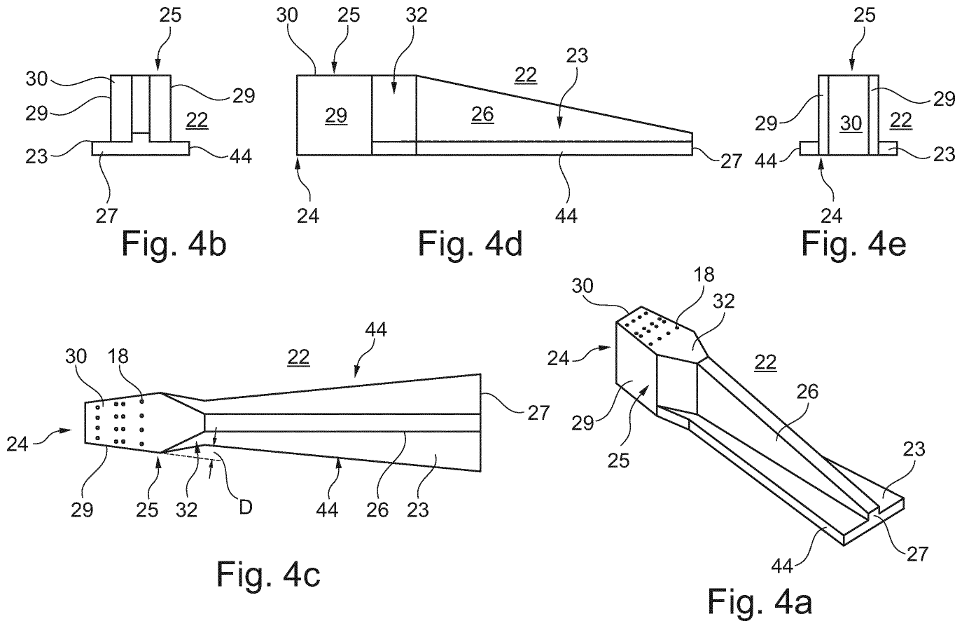

FIGS. 4a to 4e Views of a horizontal element according to the invention,

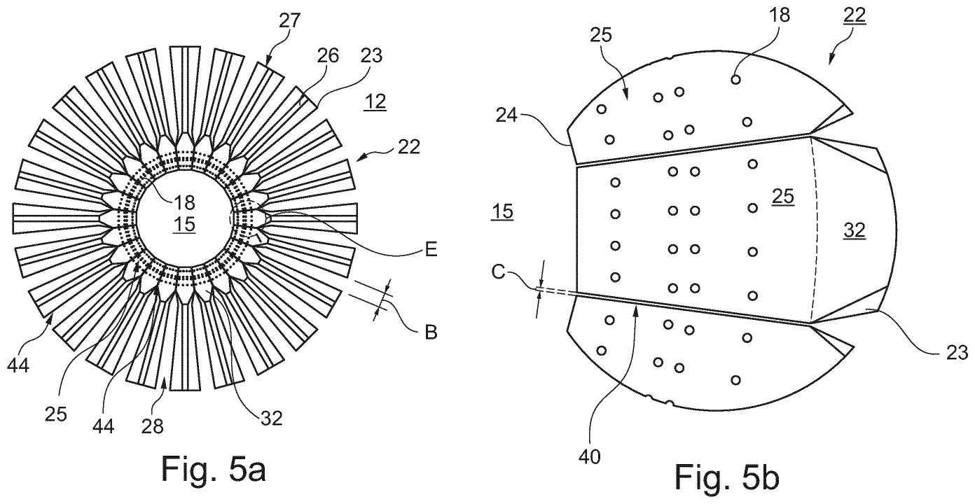

FIG. 5a a plan view of arranged surface elements of the foundation according to the invention,

FIG. 5b a detailed view of FIG. 5a,

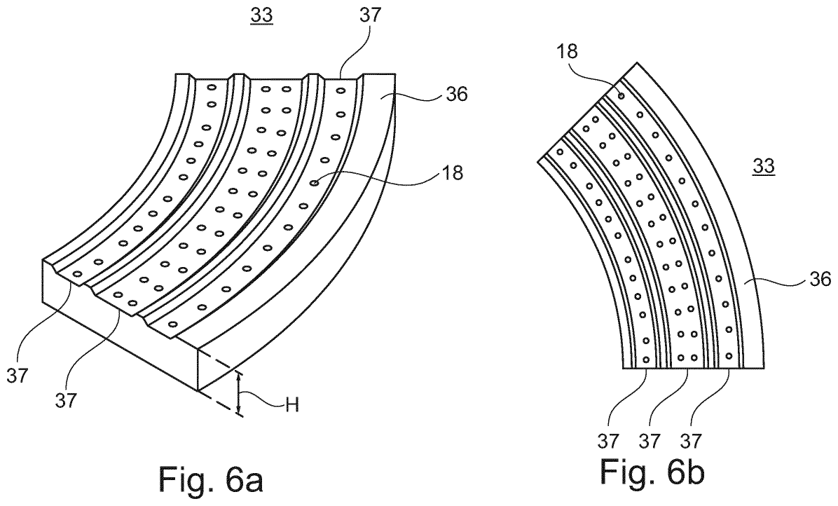

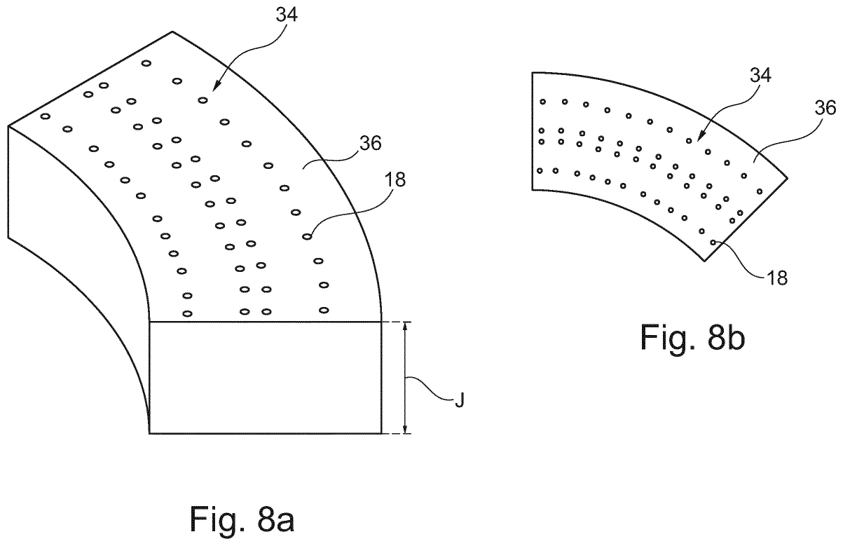

FIGS. 6a to 8b Views of base segments according to the invention in plan view and as a spatial view,

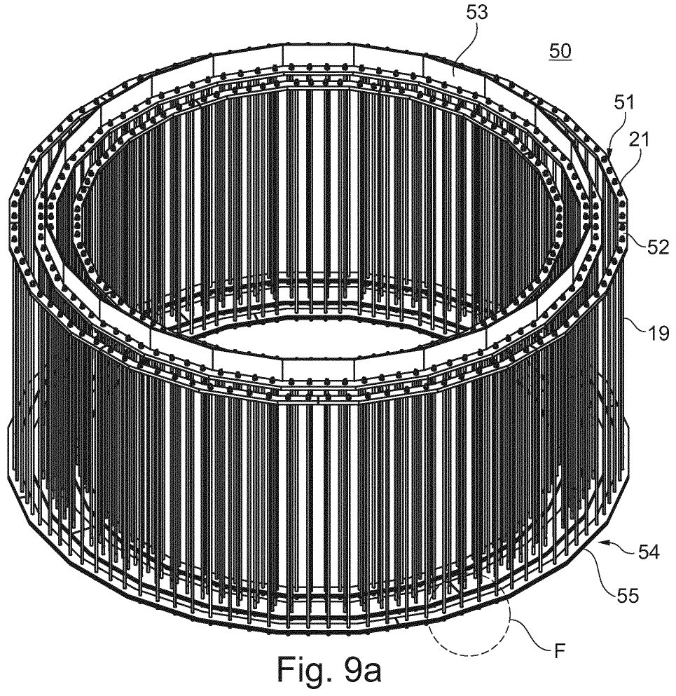

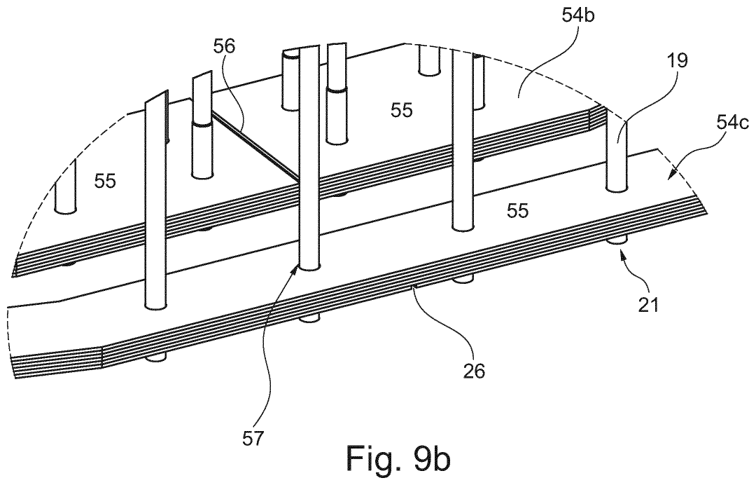

FIG. 9a a spatial view of an anchor cage according to the invention,

FIG. 9b a detailed view of FIG. 9a,

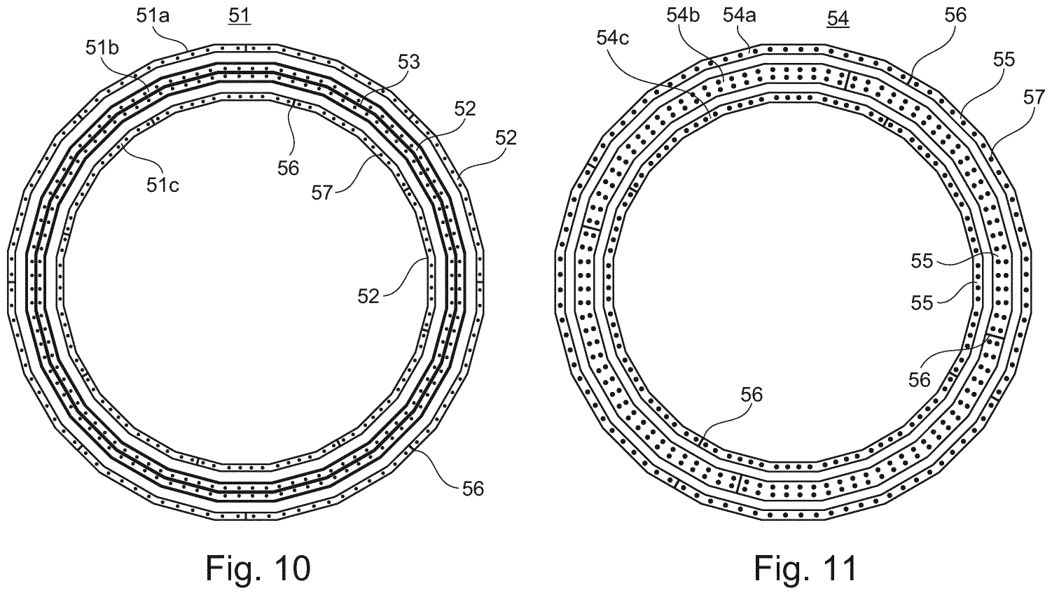

FIG. 10 a top view of an upper abutment ring of the anchor cage shown in FIG. 9a,

FIG. 11 a top view of a lower abutment ring of the anchor cage shown in FIG. 9a,

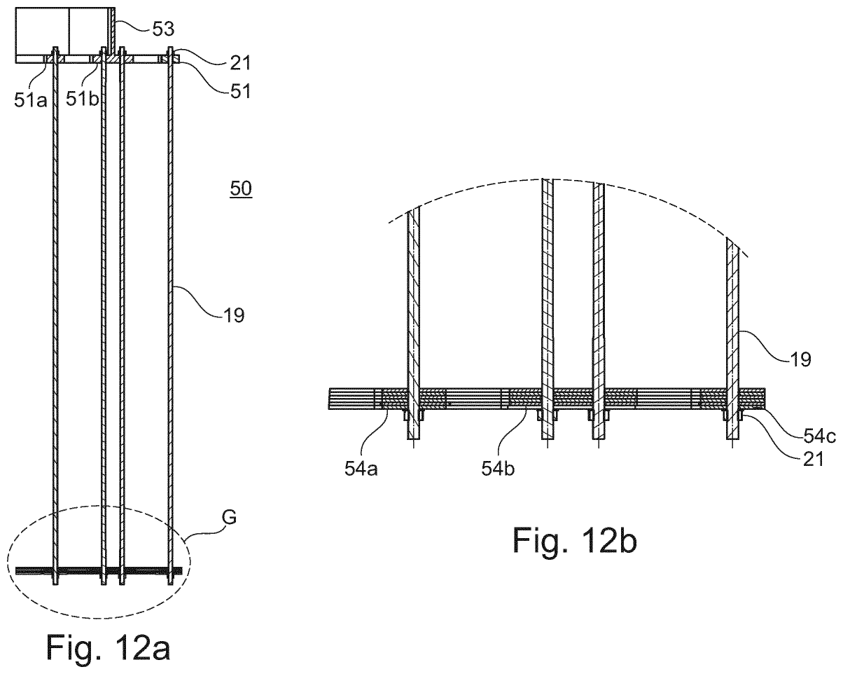

FIG. 12a, a sectional view through the anchor cage according to the invention as shown in FIG. 9a,

FIG. 12b a detailed view of FIG. 12a,

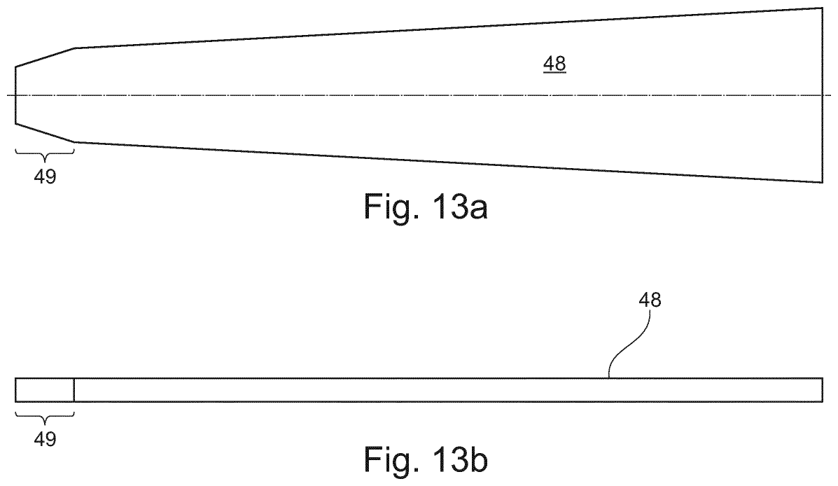

FIG. 13a, 13b atop view and a side view of a cover plate according to the invention, and

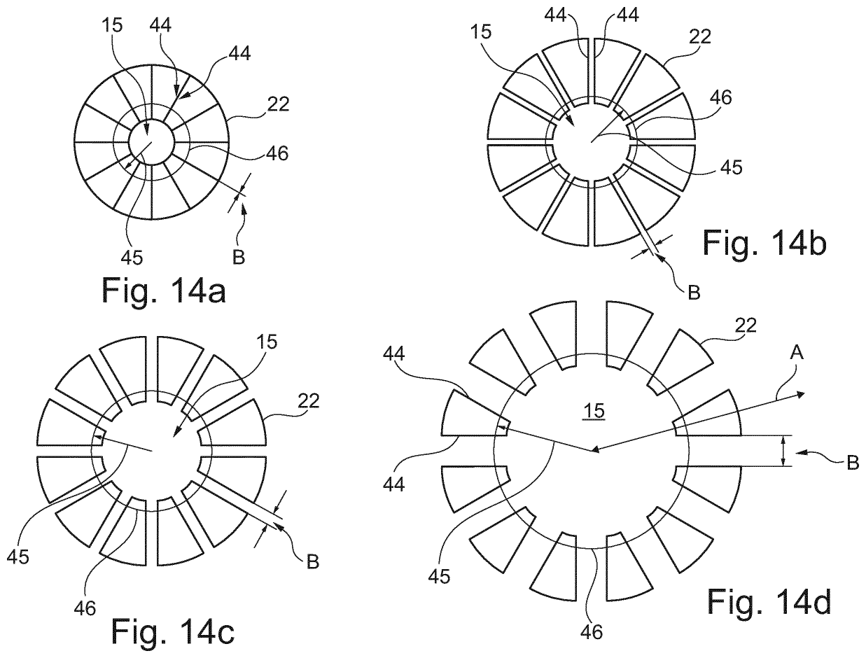

FIGS. 14a to 14d different arrangement options to FIG. 5a.

In FIG. 1, a foundation 10 according to the invention is arranged in a sectional view in a pit 101 in the ground 100, on a possibly compacted cleanliness layer 102. The foundation 10 has a first section 11 and a second section 12. Furthermore, a third section (not shown) can also optionally be provided under the second section 12, which is then preferably provided in a recess (not shown) if it should be necessary for structural reasons to extend the base further into the ground.

The first section 11 is designed as a base 20, which is built up of several layers 13, 16, 17, wherein the layers 13, 16, 17 are built up of, for example, 5 layers 13a, 13b, 16a, 17a, 17b. If necessary, further layers can be provided.

The layers 13a, 13b, 16a, 17a, 17b are constructed from closed base sections 14, which in turn are constructed from individual base segments 33, 34, 35 (see FIGS. 6a to 8b). The base sections 14 are preferably designed here as circular rings, so that the base section 11 has an interior space 15. An alternative structure, e.g. a polygonal structure, is possible.

The layers 13, 16, 17 are preferably composed here of the individual layers 13a, 13b, 16a, 17a, 17b, the layers themselves being composed of base segments 33, 34, 35 matching the layers. The uppermost layer 13 has two layers 13a, 13b. The top layer 13a is composed of base segments 33, for example as shown in FIG. 6a, 6b, with a height H. On their upper side 36, for example, three recesses 37 are provided here, into which an upper connecting flange 51 of an anchor cage 50, see FIGS. 9a to 12a, can be inserted. In the recesses 37, the openings 18 for the tendons 19 are provided.

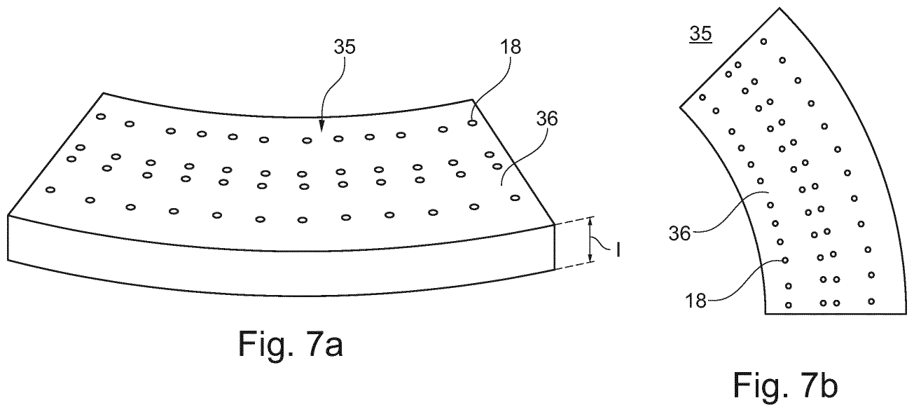

Below this, a layer 13b is provided, which is composed of base segments 35 (FIGS. 7a, 7b) with a height I, which are also provided with openings 18 for the tendons 19. The height I can be identical to the height H of the base segments 34 and is preferably the same.

Below this is the layer 16a as the middle layer 16, which is composed of base segments 34 with a height J. The base segments 34 are also provided with openings 18 for the tendons 19.

Provided below this is the lower layer 17 with layers 17a, 17b, which in turn are formed from base segments 34.

The base segments 33, 34, 35 are preferably designed very precisely with regard to the height H, I, J, i.e. with the smallest possible height deviations, in order to effect the largest possible contact surface of the base segments 33, 34, 35 on one another when these are mounted on top of one another to form the base 20 and are prestressed.

The height H, I of the base segments 33, 35 is designed in such a way that, when installed, it is essentially only loaded in tension/compression, i.e. it is subjected to a load in the normal direction. The reinforcement is also designed for this purpose (not shown), consisting essentially of reinforcement in the normal direction. Preferably, the heights H and I are the same.

The height J of the base segments 34 is designed in such a way that it is essentially only loaded in shear when installed. The reinforcement is also designed for this purpose (not shown), consisting essentially of reinforcement in the radial direction, particularly preferably in the form of stirrups.

The arrangement of segments 33, 34, 35 to form ring-like layers 13a, 13b, 16a, 17a, 17b and the arrangement layers 13a, 13b, 16a, 17a, 17b one above the other to form layers 13, 16, 17, which then form the base, is shown spatially in FIG. 2. The base segments 33, 34, 35 are provided butted side by side so that vertical gaps 38 exist between them. These are preferably designed as gaps, for example, with a thickness of several millimeters, e.g. 30 mm. These vertical joints 38 are preferably not filled with mortar or in-situ concrete. Furthermore, preferably no horizontal connecting means are provided.

Furthermore, the vertical joints of the individual layers 13a, 13b, 16a, 17a, 17b are preferably provided such that the vertical joints 38 of adjacent layers 13a, 13b, 16a, 17a, 17b are not aligned, i.e. are not arranged one above the other. As shown in FIG. 2, it is advantageous if the vertical joints 38 are always arranged offset clockwise or counterclockwise by substantially the same value.

Horizontal joints 39 exist between layers 13a, 13b, 16a, 17a, 17b and are preferably not filled with mortar or cast-in-place concrete.

The base segments 33, 34, 35 have vertical apertures 18 in which tendons 19, for example anchor rods or reinforcement rods 19 with counter elements such as nuts 21, are provided to pretension the foundation 10 during assembly. These, together with abutments 51, 54 composed of flange plates 52, 55, form an anchor cage 50. Part of the upper abutment 51 may also be the connection adapter 53 for the tower, for example if the tower is a steel tower.

The second section 12 is flat. Alternatively, however, it can also be implemented in a star shape. A top view of the foundation 10 is shown in FIG. 3. FIG. 2 shows a spatial view of the foundation 10. The second section 12 is made of horizontal elements 22 in the form of rib elements. These are shown in FIGS. 4a to 4e. These extend radially outward as viewed from the interior 15.

They have a base plate 23 that is trapezoidal in shape, for example, so that all assembled base plates form a polygonal surface (see FIGS. 3, 5a) that approximates a circular shape. Alternatively, circular segments or a mixed form of circular segment and trapezoidal shape are also possible. Spaces B can preferably be provided between side walls 44 of the base plates 23, depending on the diameter of the tower to be erected.

At the inner end 24 of the base plate 23, a support section 25 is provided with a body and side walls 29 that substantially preferably corresponds to the base 20 of the first section 11. Apertures 18 may also be provided in the support section 25. Alternatively, reinforcing bars or anchor rods 19 may be installed in the support section 25 in alignment with the apertures 18 in the first section 11 and extend outwardly from the concrete of the pedestal-like section 25 of the horizontal member 22. The base 20 with its at least one base element 14 is arranged on the support section 25.

Perpendicular to the base plate is the stiffening wall 26, the height of which decreases, for example, towards the outer end 27 of the base plate 23.

The base plate 23 is parallel tapered with respect to the side surfaces 29 of the body 30 of the support section 25. The parallel taper 31 is shown by the arrow D in FIG. 4c. This preferably achieves a reduction in material. The body 30 has a transition region 32 with which the stiffening wall 26 is connected to the support section 25 in a reinforcing manner.

Between the side surfaces 29 of the support sections 25, as shown in FIG. 5b as section E to FIG. 5a, a distance C is preferably provided as a vertical joint 40 when the horizontal elements 22 are arranged, which is preferably designed as an air gap. This results in vertical joints 40, which are also preferably not filled with mortar or in-situ concrete. Furthermore, preferably no horizontal connecting means are provided.

An upwardly open cavity 28 is formed between two adjacent stiffening walls 26, into which fill soil 104 can be placed, thereby providing a surcharge load on the second section 12 of the foundation 10.

To allow the cavities 28 to be filled with backfill soil 104 and to prevent it from entering the interior 15, barrier elements (not shown) can be placed against the body 30 of the support section 25 or transition area 32.

Furthermore, cover plates 48 (FIGS. 13a, 13b) are provided to be placed on two adjacent base plates 23 to cover the gap B between two side surfaces 44 to prevent the backfill soil 104 from entering or passing through the gap B. The cover plates 48 have a tapered section 49 that is adapted to the transition area 32. The cover plate 48 allows the full ballast load of the backfill soil 104 to be applied to the second section 12 by insertion into the cavity 28.

The interior space 15 may be backfilled with backfill soil 104 and covered with a cover element 103 after the foundation 10 is completed.

As shown in FIGS. 14a to 14d, it is possible to form a second section with a horizontal element 22 that has differently sized interior spaces 15 by moving the horizontal elements 22 inward or outward along a ray extending from the center point, as shown by the double arrow A in FIG. 19d. Inwardly, this is limited by the fact that the side surfaces 44 of the base plates 23 of the horizontal elements 22 are in contact. Outwardly, this depends on the radius of the tower to be erected, which is shown by a circle 46 in FIGS. 14a to 14d. The distance B is preferably the same over the entire length of the side surfaces 44 from the inner end 24 to the outer end 27, so that two side surfaces 44 are arranged parallel to each other. Through this, foundations for towers with different diameters can be erected in a simple manner preferably with a single horizontal element 22.

To provide the necessary bracing between the layers 13, 16, 17 of the first section and the horizontal elements 22 of the second section 12, an anchor cage 50 is formed, as shown in FIGS. 9a to 12b, which is formed by an upper and a lower abutment 51, 54, shown in FIGS. 10 and 11, which are connected to tendons 19, for example in the form of anchor bars or reinforcement bars, and counter elements 21, for example nuts.

The upper and lower abutment elements 51, 54 are composed, for example, of three concentric abutment rings 51a, 51b, 51c, 54a, 54b, 54c, of which the middle abutment ring 51b preferably contains the connection adapter 53 for the tower of the wind turbine. The abutment rings 51a, 51b, 51c, 54a, 54b, 54c can be provided from individual flange plates 52, 55, which are arranged butted together, as this is shown in FIG. 3, FIG. 9b as section F to FIG. 9a and FIG. 12b as section G to FIG. 12a. Furthermore, several flange plates 52, 55 can also be arranged one above the other. In this case, these are then preferably arranged in such a way that their vertical joints 56 do not overlap in adjacent layers of the flange plates 52, 55. Preferably, the flange plates 52, 55 are not welded to each other, but lie on or against each other. The flange plates 52, 55 have apertures 57 and can be provided with different widths and different numbers of rows of apertures 57 per flange plate 52, 55.

Preferably, the abutment ring 51b may be integral with the connection adapter 53 as a flange plate 52.

List of reference signs

| | |
|---|---|
| 10 | foundation |
| 11 | first section |
| 12 | second section |
| 13 | upper layer |
| 13a | layer |
| 13b | layer |
| 14 | base section |
| 15 | Interior space |
| 16 | middle layer |
| 16a | layer |
| 17 | lower layer |
| 17a | layer |
| 17b | layer |
| 18 | opening |
| 19 | tendon/anchor rods |
| 20 | socket |
| 21 | counter element/nut |
| 22 | horizontal element/rib element |
| 23 | base plate |
| 24 | inner end |
| 25 | bearing section |
| 26 | stiffening wall |
| 27 | external end |
| 28 | cavity |
| 29 | side wall |
| 30 | body |
| 31 | parallel taper |
| 32 | transition area |
| 33 | upper base segment |
| 34 | middle base segment |
| 35 | base segment |
| 36 | top side |
| 37 | recess |
| 38 | vertical joint |
| 39 | horizontal joint |
| 40 | vertical joint |
| 44 | side wall |
| 45 | radius |
| 46 | circle |
| 48 | cover plate |
| 49 | tapered section |
| 50 | anchor cage |
| 51 | top abutment |
| 52 | flange plate |
| 53 | connection adapter |
| 54 | lower abutment |
| 55 | flange plate |
| 56 | vertical joint |
| 100 | ground |
| 101 | pit |
| 102 | cleanliness layer |
| 103 | cover element |
| 104 | backfill soil |
| A | Shift direction |
| B | distance |
| C | distance |
| D | arrow of the parallel taper |
| E | detailed view |
| F | detailed view |
| G | detailed view |
| H | height |
| I | height |
| J | height |

1-21. (canceled)

22. A foundation for a wind turbine, comprising;
prefabricated elements of reinforced concrete, including;
a first vertically extending base-like section on which a tower of the wind turbine can be arranged, and
a second substantially horizontally extending section as a foundation body which is in contact with the ground,
wherein;
the first section is above the second section, wherein
the first vertically extending base-like section is formed of at least three layers one above the other,
the upper and lower layers are formed of at least two ring-like layers.
the middle layer is formed of at least one ring-like layer,
the height of at least one of the upper and lower layer is smaller than the height of the middle layer,
the layers are vertically braced to the second section by means of at least two vertical tendons.

23. The foundation according to claim 22, wherein the height of the upper and lower layers is smaller in total than the height of the middle layer.

24. The foundation according to claim 22, wherein at least one of the layers comprises at least one precast element.

25. The foundation according to claim 22, wherein at least one of the layers comprises at least two precast elements.

26. The foundation according to claim 22, wherein at least two adjacent layers comprise at least two precast elements.

27. The foundation according to claim 25, wherein the at least two elements are butted together and form the ring-like layer free of horizontal fastening means in vertical joints between the at least two elements.

28. The foundation according to claim 27, wherein the at least two elements are arranged in the vertical joints in at least one of a stress-free and contact-free manner.

29. The foundation according to claim 28, wherein the vertical joints of two layers lying directly one above the other are not aligned.

30. The foundation according to claim 22, wherein the prefabricated elements of at least one of the first and second section are arranged in the vertical joints in at least one of a stress-free and contact-free manner.

31. The foundation according to claim 22, wherein the prefabricated elements of at least one of the lower and upper layers have an increased reinforcement in the normal direction

32. The foundation according to the claim 22, wherein the prefabricated elements of the middle layer have at least one increased reinforcement for dissipating shear loads in the radial direction.

33. The foundation according to claim 22, wherein the at least two tendons prestress the layers whereby all horizontal joints between the layers are under pressure in operating and loaded condition of the wind turbine.

34. The foundation according to claim 22, further comprising at least two abutment rings, against which the tendons act, at least one abutment ring is on the upper side of the first section and at least one abutment ring is on the lower side of the second section.

35. The foundation according to claim 34, wherein at least one of the at least one abutment rings comprises at least two prefabricated elements butted together.

36. The foundation according to claim 34, wherein at least one of the at least one abutment ring comprises at least two layers arranged one above the other.

37. The foundation according to claim 36, wherein the layers each comprise at least two elements butted together, the butts of two layers lying directly one above the other are not aligned.

38. The foundation according to claim 22, wherein the second section is formed of at least three horizontal elements.

39. The foundation according to claim 38, wherein the horizontal elements are laterally spaced apart from one another.

40. The foundation according to claim 39, wherein the horizontal elements are laterally parallel spaced apart from one another.

41. The foundation according to claim 22, wherein the elements of the at least three layers of the first section comprise at least two substantially vertical apertures, in each of which a tension member, including at least one of a threaded rod or an anchor bolt with counter elements is disposed.
